(19) United States
(12) Patent Application Publication
(10) Pub. No.: US 2007/0111691 A1
(43) Pub. Date: May 17, 2007

(54) Signal conditioning circuit, especially for a receiver arrangement for mobile radio

(76) Inventors: Andre Hanke, Neubiberg (DE); Giuseppe Li Puma, Bochum (DE)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 11/593,283

(22) Filed: Nov. 6, 2006

Related U.S. Application Data
(63) Continuation of application No. PCT/DE05/00844, filed on May 4, 2005.

(30) Foreign Application Priority Data
May 6, 2004 (DE) DE102004022324.6

(51) Int. Cl. H04B 1/06; H04B 1/18; H04B 1/16

(52) U.S. Cl. 455/239.1; 455/293; 455/337

(57) ABSTRACT

The invention discloses a signal conditioning circuit having a vector demodulator for breaking down a signal applied to the input into a first component and a second component. The outputs of the vector demodulator having at least one first amplifier circuit comprising a first and a second input connected thereto which may be configured to amplify signals applied to the input using an adjustable gain. The outputs of the at least one first amplifier circuit are connected to a first analog/digital converter. A polyphase filter may be connected between outputs of the vector demodulator and the input of the first amplifier circuit. The polyphase filter has an adjustable filter bandwidth.

### REFERENCE TO RELATED APPLICATIONS

This application is a continuation of PCT/DE2005/000844 filed May 4, 2005 which was not published in English, that claims the benefit of the priority date of German Patent Application No. DE 10 2004 022 324.6, filed on May 6, 2004, the contents of which both are herein incorporated by reference in their entireties.

### FIELD OF THE INVENTION

The invention relates to a signal conditioning circuit, and particularly to a receiver arrangement for a mobile radio, and to a method for operating such a signal conditioning circuit.

### BACKGROUND OF THE INVENTION

Modern communication appliances may require the receiver to receive a plurality of signals encoded using different communication standards. However, different communication standards usually have different transmission bandwidths for data communication and different modulation types. Thus, a channel bandwidth of 1 MHz is provided for the Bluetooth mobile radio standard, for example, according to the specification, whereas a bandwidth of 20 MHz is used for the WLAN mobile radio standard.

To reject unwanted signals from adjacent channels, the receiver should therefore have a respective suitable input filter for the various signals. In this context, however, it should be remembered that some input filters have a phase transfer function which already has a high level of phase distortion in the region of their cutoff frequency. Since modern communication standards use encoding in the phase of the signal, among other things, this results in information being changed. The result is demodulation errors and therefore bit errors.

For this reason, the filter bandwidth of communication standards which use phase-sensitive modulation types is chosen to be somewhat greater than prescribed by the standard in order to minimize phase distortion as far as possible in this manner. In this context, a compromise is found between sufficient adjacent channel rejection and low phase distortion.

Aside from different mobile radio standards having a different bandwidth, there are also mobile radio standards which use different modulation types for their data transmission. One example of these is the Bluetooth Version 2.0 mobile radio standard. This standard has three different data transmission rates of 1 Mbit/s, 2 Mbit/s and 3 Mbit/s. At the lowest data rate, GFSK modulation is used for transmission, which encodes data using frequency hopping, that is to say is insensitive to a change in amplitude. Such a signal is also called an envelope. For the two other transmission rates, π/4-DQPSK or 8-DPSK modulation is used. These two modulation types encode the information to be transmitted in the amplitude and the phase of the signal.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present one or more concepts of the invention in a simplified form as a prelude to the more detailed description that is presented later.

The present invention relates to a signal conditioning circuit, and particularly to a reception arrangement, in which a phase error in a received signal is minimized.

In this embodiment of the present invention, a signal conditioning circuit comprises a vector demodulator having an input and a first and a second output. The vector demodulator may be configured to break down a signal applied to the input into a first component and into a second component and to output the first component and the second component. In addition, at least one first amplifier circuit having a first and a second input is provided, these inputs being coupled to the outputs of the vector demodulator. In this arrangement, the at least one amplifier circuit may be configured to amplify signals applied to the input using an adjustable gain factor. A first output of the at least one amplifier circuit has a first analog/digital converter connected to it, and a second output of the at least one first amplifier circuit has a second analog/digital converter connected to it. The first and the second analog/digital converter are respectively configured to output a digital value at their outputs which is derived from an applied signal. The inputs of the at least one first amplifier circuit and the outputs of the vector demodulator are coupled via a polyphase filter which has an adjustable filter bandwidth. The polyphase filter contains a start input for supplying a start signal for adjusting the filter bandwidth.

In one embodiment, the inventive signal conditioning circuit is provided in a receiver arrangement, or forms part of a receiver arrangement. In another refinement, a second amplifier circuit is connected in parallel with the first amplifier circuit and having first and second inputs connected to the outputs of the polyphase filter. A first and a second output of the second amplifier circuit are connected in parallel having a third and a fourth analog/digital converter, respectively, connected downstream therefrom. In this embodiment, in contrast to the first amplifier circuit, the second amplifier circuit may be configured as an amplifier circuit with a limiting gain response.

Accordingly, the first amplifier circuit forms a first amplifier path whose gain response can be adjusted accordingly and the second parallel-connected amplifier circuit forms a second amplifier path with a fixed, limiting gain response.

The polyphase filter with an adjustable filter bandwidth allows a significant space reduction to be achieved in the signal conditioning circuit, since a design with a plurality of switchable polyphase filters with a respective different filter bandwidth is no longer necessary. In this context, the filter bandwidth is dependent on the modulation type used. A filter bandwidth which ensures adequate rejection of adjacent channels and at the same time contains only low phase distortion may be adjusted in the polyphase filter in suitable fashion.

When the input has a signal applied to it having information encoded in the phase, the error rate is reduced. At the same time, the inventive signal conditioning circuit may be used in a receiver arrangement for different mobile radio standards.

In one embodiment of the invention, a switching device is provided which, on the basis of specified parameters, and in one embodiment a selected mobile radio standard, may be configured to produce a start signal for adjusting a filter bandwidth for the polyphase filter and to activate and deactivate the first or the second amplifier circuit. In this embodiment, the first and/or the second amplifier circuit have a signal input for activating and deactivating the relevant amplifier circuit. This allows the amplifier circuit that is not required for the modulation type to be turned off and thus allows the power consumption in the inventive reception arrangement to be reduced.

In one preferred embodiment, the vector modulator is configured as an I/Q demodulator. In one embodiment of the invention, the vector modulator is produced as an I/Q modulator such that a signal applied to the input can be converted into an inphase component and a quadrature component on the center frequency of 0 hertz. This makes it possible to implement particularly simple later digital signal handling and particularly simply configured polyphase filters.

In another embodiment of the invention, the polyphase filter with an adjustable filter bandwidth may be configured as an active RC filter with operational amplifiers. Alternatively, the polyphase filter may be configured as a gₘC filter or may comprise another such filter. In another embodiment, the polyphase filter comprises at least two variable capacitance charge stores for the purpose of adjusting the filter bandwidth. The variable capacitance charge stores are respectively connected to the start input of the polyphase filter for the purpose of varying the capacitance. The change in the capacitance allows the polyphase filter's filter bandwidth to be varied. In an alternate embodiment and as an addition to this embodiment, the polyphase filter in another configuration comprises at least two resistors which have variable resistance values. In this context, the resistance value can be adjusted by the start signal.

In one embodiment of the invention, the polyphase filter may be configured as a higher-order polyphase filter. In one embodiment, the polyphase filter may have a Chebyshev filter characteristic or a Butterworth filter characteristic. Both filter characteristics are distinguished by a particularly high level of attenuation at the cutoff frequency, while at the same time having a substantially constant transfer function within the bandwidth. Naturally, other filter transfer functions may also be used.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a functional block diagram of a first exemplary embodiment of the invention;

FIG. 2 is a functional block diagram of a second exemplary embodiment of the invention;

FIG. 3 is a functional block diagram of a receiver with a third embodiment of the invention;

FIG. 4 is a schematic diagram of an embodiment of a polyphase filter using active RC filter technology;

FIG. 5 is a schematic diagram of an embodiment of a polyphase filter using gₘC filter technology;

FIG. 6 is a schematic diagram of an embodiment of an adjustable capacitance charge store; and

FIG. 7 is a schematic of the format for a data packet based on the Bluetooth standard Version 2.0.

### DETAILED DESCRIPTION OF THE INVENTION

One or more implementations of the present invention will now be described with reference to the attached drawings, wherein like reference numerals are used to refer to like elements throughout, and wherein the illustrated structures are not necessarily drawn to scale.

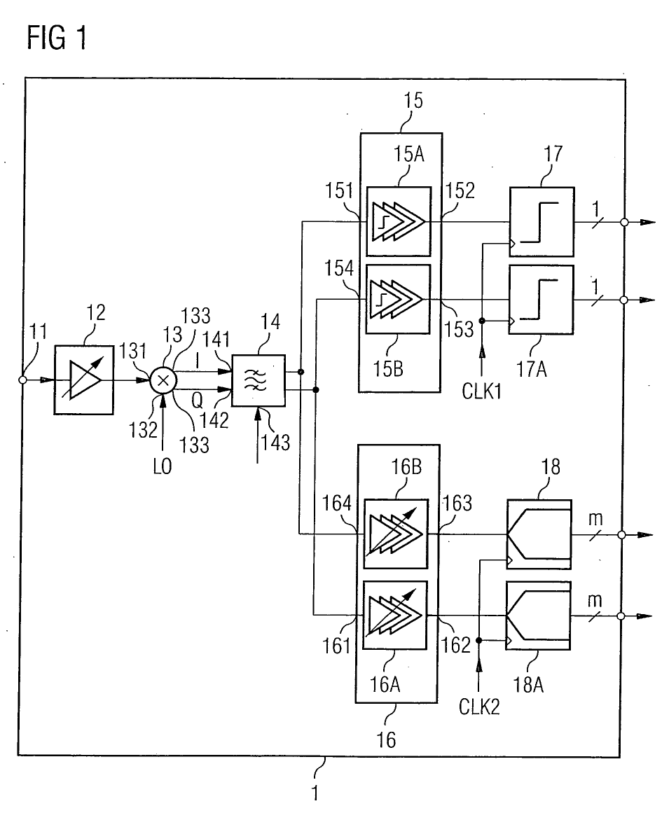

FIG. 1 illustrates an inventive signal conditioning circuit which is implemented in a semiconductor body 1. The signal conditioning circuit is part of a receiver for mobile radio signals based on Bluetooth standard Version 2.0. However, in another embodiment of the present invention, the signal conditioning circuit may be configured to process signals from other mobile radio standards.

The surface of the semiconductor body 1 may have a plurality of different connection contacts for supplying input signals and for providing appropriate output signals after signal processing by the inventive signal conditioning circuit. The semiconductor body 1 thus may contain a connection which forms an input 11 for a received signal. The signal input 11 may be connected to a low-noise amplifier 12 which amplifies the received signal using an adjustable gain factor. High demands may be placed on the input amplifier 12 in terms of linearity of the amplifier and noise factor.

The output of the linear low-noise amplifier 12 may be connected to an input 131 of an I/Q demodulator 13. The I/Q demodulator 13 also contains a local oscillator input 132 to which a local oscillator signal LO 132 is supplied. Using the local oscillator signal, the I/Q demodulator 13 breaks down a signal applied to its signal input 131 and produces an inphase component I and a quadrature component Q therefrom. These components are provided at an output 133.

The I/Q demodulator 13 may also be used to perform frequency conversion to an intermediate frequency of 0 Hz, for example. This operation is also called direct conversion and produces a complex baseband signal comprising the inphase component I and the quadrature component Q. A suitable choice for the frequency of a local oscillator signal LO 132 thus allows signals applied to the input which come from a wide variety of mobile radio standards to be converted into their complex signal components I and Q and to a suitable baseband signal.

The outputs of the I/Q demodulator 13 are respectively connected to an input 141 and 142 of a polyphase filter 14. The polyphase filter also has a start input 143. This start input 143 can be supplied with a signal for adjusting a filter bandwidth for the polyphase filter 14. The polyphase filter 14 rejects the image frequency component within the inphase component I and the quadrature component Q and outputs the unrejected components to its output. Adjusting the filter bandwidth varies the transfer characteristic of the polyphase filter 14. The filter bandwidth of the polyphase filter 14 can therefore be tuned to the bandwidth of the signal I and Q applied to the input. In addition, the filter bandwidth of the polyphase filter 14 can be adjusted such that phase distortion as a result of the transfer function of the filter at the cutoff frequency of the filter bandwidth is avoided.

The outputs of the polyphase filter 14 are connected to the inputs 151 and 154, and 161 and 164, of a first amplifier circuit 16 and a second amplifier circuit 15. The amplifier circuit 16 comprises two individual amplifier stages 16a and 16b whose gain can be adjusted in discrete steps. They are therefore called PGC amplifiers (Programmable Gain Control amplifiers). Using an adjustable gain, a received signal can thus be amplified with a linear gain response. Distortions in the amplitude and also in the phase may be reduced or even totally avoided as a result.

The second amplifier circuit arrangement 15 comprises two limiting amplifier stages 15a and 15b. Each of the two amplifier stages is connected to one of the two inputs 151 and 154. The limiting amplifier stages do not amplify a signal applied to the input in a linear fashion, but rather output a limited maximum signal at their outputs 152 and 153 which is independent of an amplitude of the input signal. For converted and filtered received signals which contain information in their amplitude or in their phase, this amplifier path may be unsuitable. Consequently, the amplifier circuit 16 may be used primarily for signals which are amplitude or phase sensitive, while the amplifier circuit 15 may be used for signals which are not amplitude sensitive.

The outputs 162 and 163 are respectively connected to an analog/digital converter 18 and 18A. This converts signals applied to the input using a clock signal CLK2 of 8 MHz and produces an m-bit digital value therefrom. The digital value which can be tapped off at the output of the analog/digital converter 18A corresponds to the quadrature component Q of the signal converted by the I/Q demodulator. The bit value which can be tapped off at the output of the analog/digital converter 18 corresponds to the inphase component I.

The outputs 152 and 153 of the second amplifier circuit 15 likewise have analog/digital converters 17 and 17a connected to them. These also have a clock signal input for supplying a first clock signal CLK1. In the present exemplary embodiment, the analog/digital converters 17 and 17a may be configured as 1-bit converters with simple comparators. They are operated at a clock rate of the clock signal CLK1 of 104 MHz. The signal which is applied to the input and which is amplified to a limited extent by the second amplifier circuit 15 is sampled at the clock rate of 104 MHz and a corresponding string of single-value bits is output at the outputs. The high oversampling rate means that it is also possible for wideband signals to be processed correctly at high data transmission rates. The outputs of the respective analog/digital converters 17, 17a, 18 and 18A are routed to appropriate connections on the surface of the semiconductor body 1. The signals which can be tapped off there can be processed further digitally in additional integrated circuits.

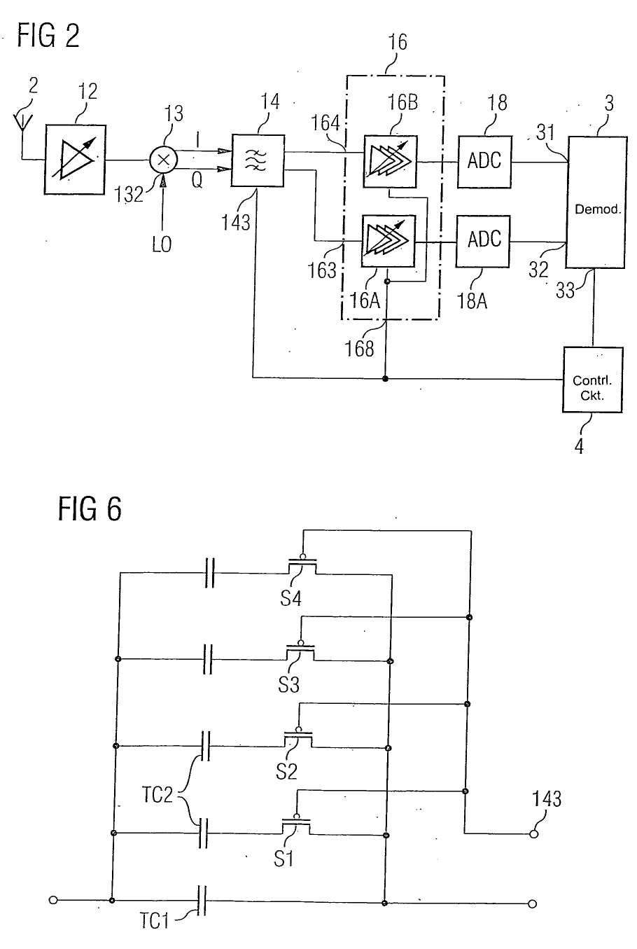

FIG. 2 illustrates a second embodiment of the invention, produced using discrete components. In this embodiment, the inventive signal conditioning circuit may be part of a receiver path in a transceiver, which is not shown here for reasons of clarity. The transceiver may be configured to receive signals from various mobile radio standards. Since the latter may place different demands on signal quality, it may be necessary to choose a flexible concept.

The reception path illustrated in FIG. 2 further comprises an antenna 2 which is connected to the input of the low-noise amplifier 12. A vector demodulator 13 uses a local oscillator signal LO at the local oscillator input 132 to convert the signal coming from the amplifier 12 to an intermediate frequency, and at the same time breaks down this intermediate frequency into the complex components I and Q. These components are supplied to the polyphase filter 14. The polyphase filter can have its filter bandwidth adjusted over a wide range. An optimum bandwidth can therefore be selected according to the signal received. The filter bandwidth is adjusted using a signal at the control input 143. The outputs of the polyphase filter are connected to the inputs 163 and 164 of the amplifier circuit 16. The polyphase filter is in turn equipped with an adjustable filter bandwidth. The adjustment is made rapidly, which means that even during a data transmission it is possible to change over during a useful data transmission. The amplifier circuit 16 also contains a start input 168 connected to the individual amplifier stages 16a and 16b.

A signal at the start input 168 permits substantially precise gain adjustment for the individual amplifier stages 16a and 16b within the amplifier circuit 16. The outputs of the amplifier stages 16a and 16b are connected to the inputs of the analog converters 18A and 18, respectively. The outputs of the analog converters 18 and 18A are routed to two inputs 31 and 32, respectively, of a demodulation arrangement 3. The demodulation arrangement 3 demodulates the digital signals applied to the input and produces therefrom a bit string which represents the data content of the received signal. This data content is processed further. Concurrently, the demodulation device 3 produces a plurality of parameter signals at an output 33 and transfers them to a control device 4.

The control device 4 forms various control signals therefrom. These control signals are used firstly to adjust a filter bandwidth for the polyphase filter 14 and to vary the gain of the two amplifier stages 16a and 16b in the amplifier circuit 16. The parameters which were transferred from the demodulation arrangement 3 to the control device 4 are dependent on the quality of the signal applied to the input. If the filter bandwidth of the polyphase filter is adjusted incorrectly then the error rate of the demodulation increases. If the filter bandwidth is chosen to be too small, for example, then phase errors in the digitized signal may accumulate. Linearity errors are obtained when the gain of the two amplifier stages 16a and 16b is adjusted above a preset high limit. In one embodiment, the various errors within the demodulation arrangement 3 may be identified, and the appropriate parameters can be transferred to the control device 4.

Another embodiment provides for adjusting a suitable filter bandwidth for the polyphase filter 14 when the data content of the received and demodulated signal allows conclusions to be drawn about the imminent modulation type and the imminent bandwidth of a received signal. This is the case with the Bluetooth mobile radio standard, for example.

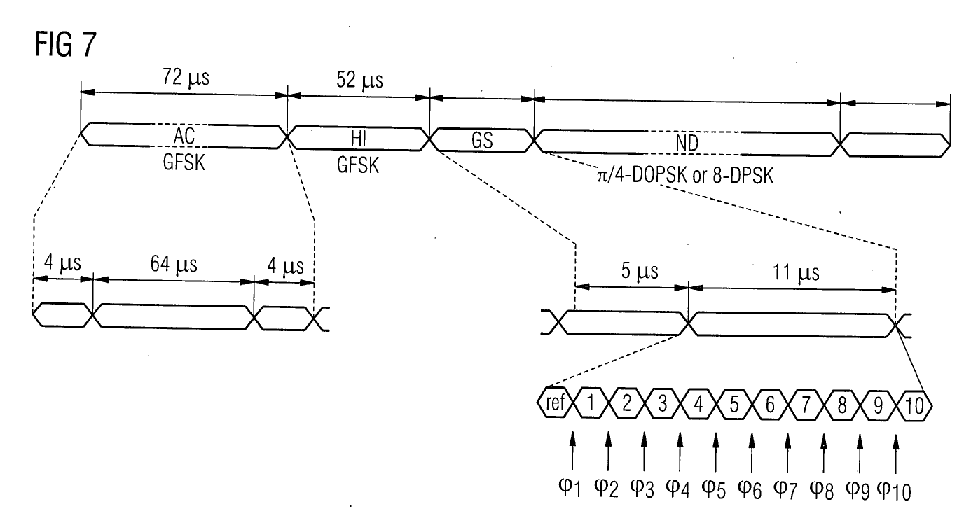

Received signals and signals to be transmitted based on the Bluetooth standard are packet oriented. FIG. 7 illustrates a format for a packet-oriented Bluetooth signal.

In the embodiment of FIG. 7, the data packet is divided into five parts which are sent in succession. The first part comprises an access code AC with a length of 72 μs, in which the data rate is firmly prescribed and the modulation type GFSK is used. The data content of the access code AC allows the mobile radio station to perform identification to determine whether the subsequent data are intended for the mobile radio station, i.e. whether the mobile radio station is in the same piconet. In this context, piconet denotes the number of Bluetooth mobile stations which have the same identification.

The second part HI of the overall data packet lasts 52 μs and contains the header information. The header contains, among other things, the modulation type and the length of the subsequent useful data packet ND. The third part GS, which is a total of 16 μs long, comprises a waiting period of 5 μs and also a synchronization sequence of a total of 11 μs. The waiting period allows the channel bandwidth of the polyphase filter 14 and the gain adjustment of the amplifier circuit 16 to be made in suitable fashion. The channel bandwidth for the polyphase filter and also the gain adjustment for the amplifiers are dependent on the modulation type which is used for transmitting the useful data ND.

Version 2.0 of the Bluetooth mobile radio standard has a total of three modulation types available. With a data transmission rate of 1 Mbit/s, the useful data are encoded and transmitted using GFSK modulation. This modulation contains no information in the amplitude or phase of the signal. The moderate data rates of 2 Mbit/s and 3 Mbit/s use the amplitude and phase sensitive modulation types π/4-DQPSK and 8-DPSK. In the exemplary embodiment of an inventive reception arrangement as shown in FIG. 2, following the demodulation of the packet information, the demodulation arrangement 3 transmits the relevant parameters to the control device 4, which then adjusts the channel bandwidth of the polyphase filter and makes a suitable gain adjustment.

If, for example, the packet information provides a moderate data transmission rate of 2 Mbit/s with π/4-DQPSK modulation for the useful data ND, the filter bandwidth of the polyphase filter 14 is adjusted to 800 kHz. The filter bandwidth therefore becomes somewhat wider than the bandwidth of 650 kHz used for GFSK modulation. This reduces phase distortion because of the transfer function of the polyphase filter 14 at the cutoff frequency of the filter transfer function, and the bit error rate in the subsequent demodulation of the useful data is reduced. At the same time, a suitable gain adjustment is made for the amplifiers 16a and 16b.

This is dependent on a signal level for the access code AC and the packet information HI in the second part of the Bluetooth packet. The gain of the amplifiers 16a and 16b is adjusted such that they operate in as linear a gain range as possible and thus minimize distortion of the signal applied to the input. As a result, the amplitudes and phase information are maintained for the moderate and high data transmission rates.

If, by contrast, the evaluation of the packet information shows that a low data transmission rate is provided for the useful data then the polyphase filter 14 is adjusted to a filter bandwidth of 650 kHz. At the same time, the regulating amplifiers 16a and 16b are set to a limiting gain range.

Another embodiment of the invention is illustrated in FIG. 3. Components whose manner of operation is the same bear the same reference symbols herein. FIG. 3 illustrates an inventive signal conditioning circuit in a semiconductor body 1 whose outputs are connected to inputs 51 and 52 of a second semiconductor body 5. The second semiconductor body 5 contains integrated circuits for further signal processing and is one possible exemplary embodiment of a demodulation arrangement 3 for the receiver.

The input 11 for the received signal is connected to a linear amplifier 12 which is in turn coupled to an I/Q demodulator 13. The output of the I/Q demodulator has a second amplifier circuit 12a connected downstream whose output is connected to the input of the polyphase filter 14.

The semiconductor body 1 also comprises the control circuit 4, which is connected to the start input 701 of the polyphase filter 14 and to the control input of the first amplifier circuit 16. The second, limiting amplifier circuit 15 is also connected to a device 6 which may be configured to measure power, known as a Radio Signal Strength Indicator or RSSI measurement. The ascertained results from this RSSI measurement are processed further both in the control circuit 4 and in a signal processor (not shown here). The signal processor transfers the suitable parameters to the control circuit 4 for adjusting the amplifier circuit 16 or 15. In particular, the control circuit 4 can put one of the two amplifier paths with the amplifier circuits and analog/digital converters contained therein into an inactive operating state and thus deactivate it. This allows a power savings, since only the amplifier circuit which is needed for suitable amplification is ever active.

The device 6 for RSSI measurement may also be connected to the amplifier 16. In this embodiment, during an RSSI measurement by the device 6 in the amplifier path with the circuit 16, a signal can be simultaneously amplified and processed further in the first amplifier path using the amplifier circuit 15. This tends to reduce any effects as a result of the RSSI measurement during data reception.

The two outputs of the first semiconductor body 1 for the digital signals are connected to the inputs 51 and 52. The input 51 is connected to a decimator 55 via a further digital mixer having a local oscillator input. The digital and decimated signal is supplied to a demodulator 57 via a second filter 56. The demodulator 57 produces therefrom a binary data stream with a data rate of 1 Mbit/s. The demodulator 57 is in one embodiment a delay demodulator.

The second digital input 52 is likewise connected to a mixer 54a. The output of the digital mixer 54a is connected to a circuit via a filter 56a and a delay demodulator 58, the circuit taking the digital signal and extracting the relevant bit string in accordance with the I/Q diagrams shown herein. Downstream of the demodulators 57 and 58 there is therefore again a real signal configured as a string of bits. The output of the circuit 59 is connected to a multiplexer 70. In addition, the output of the demodulator 57 is also connected to a second input of the multiplexer 70 via a further low-pass filter 56b. The multiplexer 70 contains a start input 701 which is connected to the control circuit 4. The output of the multiplexer 70 is routed to a circuit 71 which may be configured to ascertain the exact synchronization times T.

The optimum sampling phase may be ascertained using a correlator in the circuit 71. The correlator may be supplied with the oversampled samples of the demodulated signal as input values. The correlator compares these samples with the values which are to be expected for a fixed data string, for example a fixed and known access code (AC). The optimum sampling phase may then be obtained when the correlation is at a maximum. The synchronization times are needed for correct demodulation of the data.

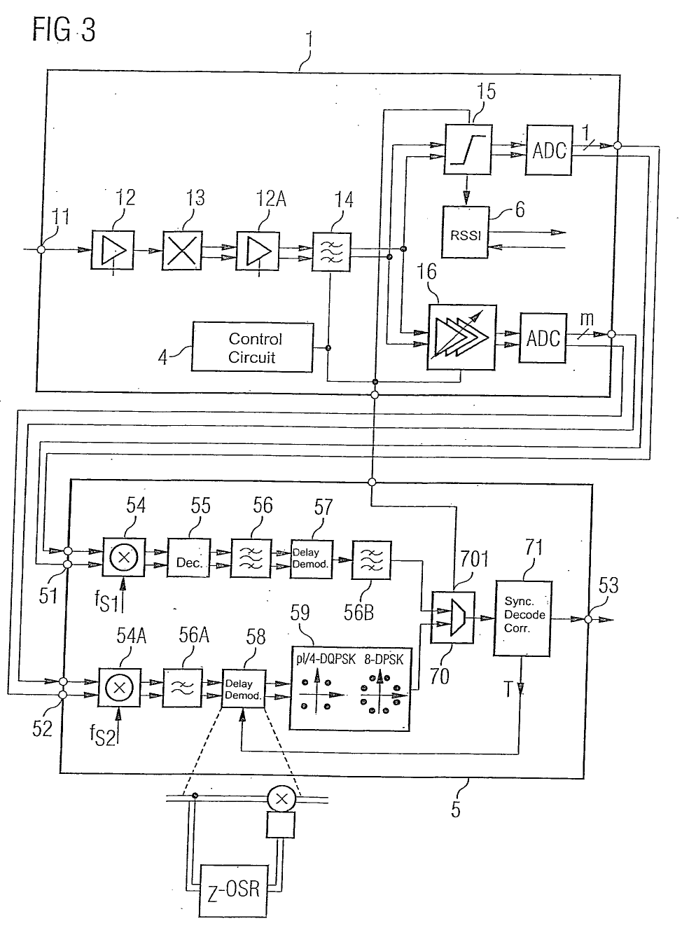

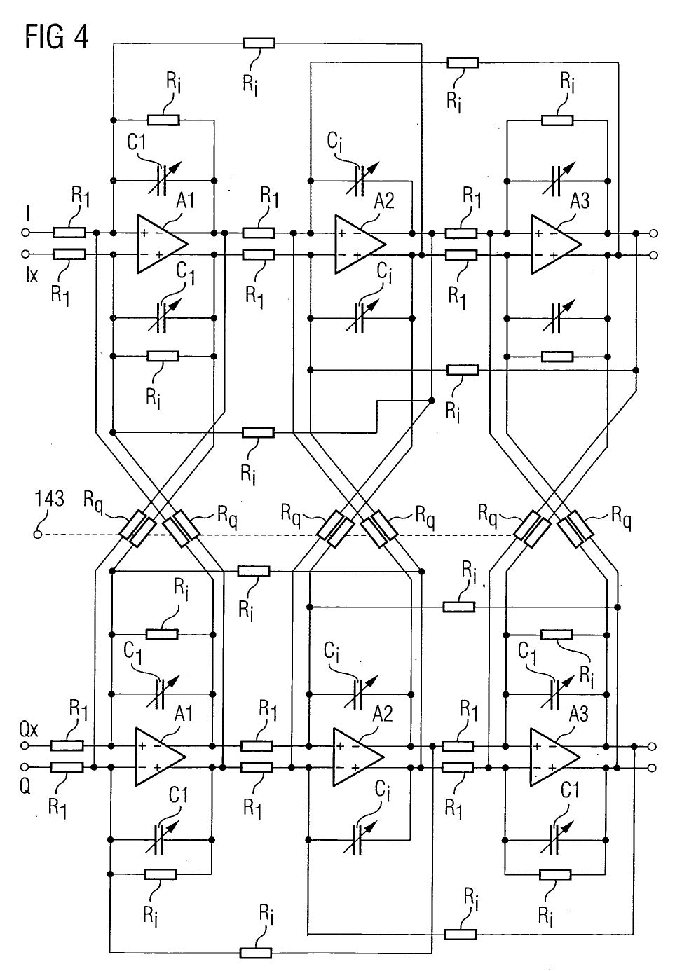

An exemplary embodiment of a polyphase filter in an inventive signal conditioning circuit is shown in FIG. 4. In this embodiment, the polyphase filter may be configured as a third order active RC polyphase filter for differential signal processing. The connections I and IX comprise the input 141 and the connections Q and QX comprise the input 142 of the polyphase filter 14. The input connections I, IX and Q, QX are connected to the inputs of a respective first amplifier A1 via first resistors R1. The outputs of the respective first amplifiers A1 in the two phases I, IX and Q, QX are in turn connected to the inputs of a second amplifier A2 via resistors R1. Finally, the outputs of each second amplifier A2 are connected to inputs of a respective third amplifier A3. Connected in parallel with the inputs and outputs of the respective amplifiers A1, A2 and A3 for the individual signal paths I, IX and Q, QX are variable capacitors Ci and resistors Ri. The capacitors Ci and the resistors Ri comprise the frequency-determining elements for the frequency bandwidth of the polyphase filter 14. These are respectively connected to an adjusting input 143, indicated here by the dashed line. Depending on control signals at this input, it is possible to adjust the value of the resistors Ri or the capacitance of the capacitors Ci.

In addition, the connections I and IX are cross-connected to the output connections of the first amplifier A2 for the signal path Q and QX via the resistors Rq after the first resistor R1 and before the input of the first amplifier A1. The output of the first amplifier A1 for the signal path I or IX is connected to the input connections of the first amplifier for the differential signal Q and QX via the resistors Rq. Specifically, the noninverting input of each amplifier for the inphase component is coupled to the inverting output of the respective amplifier for the quadrature component, and the inverting input of each amplifier for the inphase component is coupled to the noninverting output of the respective amplifier for the quadrature component, via resistors Rq. The noninverting output of each amplifier for the inphase component is coupled to the noninverting input of the respective amplifier for the quadrature component, and the inverting output of each amplifier for the inphase component is coupled to the inverting input of the respective amplifier for the quadrature component, via resistors Rq.

This circuitry comprises a first order polyphase filter and is used to reject the respective image frequency component in the complex signal I and Q. In the same way, further resistors Rq are configured as the second and third pole points in the polyphase filter 14. These resistors Rq connect the input connections of the respective second amplifiers in the signal paths for the differential signals I, IX and Q, QX.

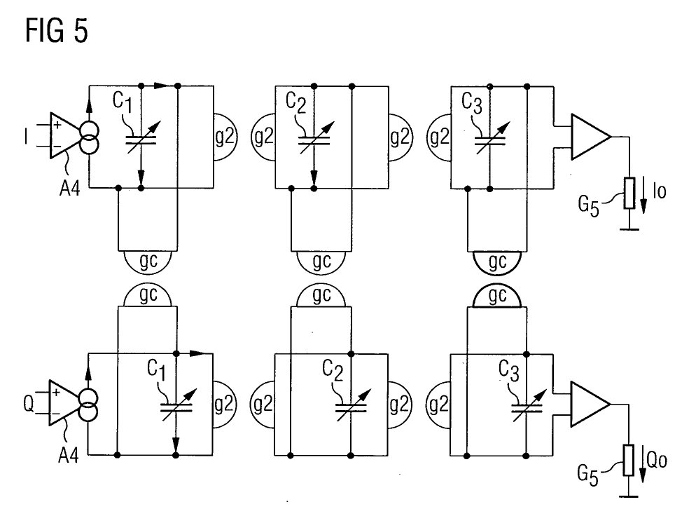

Another embodiment of the polyphase filter 14 having adjustable channel bandwidth is illustrated in FIG. 5. In FIG. 5, the polyphase filter may be configured as a third order gmC filter for normal mode signal processing. The inputs for the inphase component and the quadrature component are respectively provided to a transconductance amplifier A4. These arrangements comprise voltage/current converters which use their voltage to convert an input voltage into a proportional current. The indicated coupling gc between the inphase component I and the quadrature component Q for each filter order is configured as a gyrator. At the output, the signal is converted back into a voltage signal using a load resistor connected to ground. The gradient of each transconductance amplifier in the gyrators and the change in capacitance of the adjustable capacitors C1, C2 and C3 make it possible to achieve a change in the filter transfer characteristic of the polyphase filter.

An embodiment of the adjustable capacitances for the polyphase filters 14 is shown in FIG. 6. In FIG. 6, a first fixed capacitance TC1 is connected between the input connection and the output connection. Further capacitor elements TC2, TC3 to TC5 are arranged in parallel with the first fixed capacitor element TC1. The capacitance values of the capacitor elements TC2, TC3 to TC5 may be chosen to be of the same magnitude. A connection in parallel with the first fixed capacitor element TC1 is made via the switches S1, S2 to S4, which are formed from respective P-MOS field effect transistors, for example. The switch is closed through actuation at an appropriate potential on the control line, which comprises the start input 143 for the polyphase filter.

Although the invention has been shown and described with respect to one or more implementations, equivalent alterations and modifications will occur to others skilled in the art based upon a reading and understanding of this specification and the annexed drawings. The invention includes all such modifications and alterations and is limited only by the scope of the following claims. In addition, while a particular feature or aspect of the invention may have been disclosed with respect to only one of several implementations, such feature or aspect may be combined with one or more other features or aspects of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.” Also, the term “exemplary” is merely meant to mean an example, rather than the best. It is also to be appreciated that layers and/or elements depicted herein are illustrated with particular dimensions relative to one another (e.g., layer to layer dimensions and/or orientations) for purposes of simplicity and ease of understanding, and that actual dimensions of the elements may differ substantially from that illustrated herein.

What is claimed is:

1. A signal conditioning circuit, comprising:
a vector demodulator having an input and a first and a second output, which is configured to break down a signal applied to the input into a first component and a second component and to output the first component to the first output and the second component to the second output;
a polyphase filter having an adjustable filter bandwidth and a first and a second input connected to the first and second outputs of the vector demodulator, the polyphase filter having a start input configured to receive a start signal for adjusting the filter bandwidth;
a first amplifier circuit comprising a first input connected to a first output of the polyphase filter and a second input connected to a second output of the polyphase filter, wherein the first amplifier circuit is configured to amplify signals applied to the input using an adjustable gain factor;
a first analog/digital converter, connected to a first output of the amplifier circuit, and a second analog/digital converter, connected to a second output of the amplifier circuit, the first and the second analog/digital converter being configured to output a digital value derived from a signal input applied thereto; and
a second amplifier circuit arranged in parallel with the first amplifier circuit comprising first and second outputs having a third and a fourth analog/digital converter connected to the first and second outputs.

2. The signal conditioning circuit of claim 1, wherein the second amplifier circuit is configured as an amplifier circuit having a limiting gain response.

3. The signal conditioning circuit of claim 1, wherein one or more of the first amplifier circuit and the second amplifier circuit, respectively, comprise at least two amplifiers, having a first amplifier from the at least two amplifiers configured to amplify and output a signal applied to the first input, and a second amplifier from the at least two amplifiers configured to amplify and output a signal applied to the second input.

4. The signal conditioning circuit of claim 1, wherein the first amplifier circuit is configured as a programmable amplifier circuit having a setting input supplied with a start signal for adjusting the gain factor.

5. The signal conditioning circuit of claim 1, wherein the vector demodulator is configured as an I/Q demodulator having a signal input, a local oscillator input, and an output for converting a signal applied to the input with a local oscillator signal on the local oscillator input and for providing an output signal, the output signal provided comprising an inphase component and a quadrature component.

6. The signal conditioning circuit of claim 1, wherein the polyphase filter having an adjustable filter bandwidth is configured as an active RC filter comprising operational amplifiers.

7. The signal conditioning circuit of claim 1, wherein the polyphase filter having an adjustable filter bandwidth is configured as a gmC filter comprising transconductance amplifiers.

8. The signal conditioning circuit of claim 1, wherein the polyphase filter comprises at least two variable capacitance charge stores used for adjusting the filter bandwidth, the variable capacitance charge stores each having a setting input connected to the start input of the polyphase filter for varying the capacitance.

9. The signal conditioning circuit of claim 8, wherein the variable capacitance charge store has a first charge store element and at least one second charge store element, which is arranged in parallel with the first charge store element and which is configured to be coupled to the first charge store element via a switch, the switch having a switching input which is coupled to the setting input of the polyphase filter.

10. The signal conditioning circuit of claim 1, wherein the polyphase filter comprises, for adjusting the filter bandwidth, at least one resistor having a variable resistance value, the resistance value of the at least one variable resistor configured to be adjusted by a start signal.

11. The signal conditioning circuit of claim 1, wherein the polyphase filter comprises a Chebyshev filter characteristic or a Butterworth filter characteristic.

12. The signal conditioning circuit of claim 1, wherein one or more of the first amplifier circuit and the second amplifier circuit have a first and a second operating state adjusted by means of a control signal, the first and the second amplifier circuit configured to amplify in the first operating state and to be turned off in the second operating state.

13. The signal conditioning circuit of claim 1, wherein the first and second analog/digital converters have a clock signal input for supplying a first clock signal and are configured to output a value comprising a plurality of bits.

14. The signal conditioning circuit of claim 1, wherein the third and fourth analog/digital converters have a clock signal input for supplying a second clock signal and are configured to output a value representing one bit.

15. The signal conditioning circuit of claim 1, wherein the signal conditioning circuit is configured as an integrated circuit in a semiconductor body.

16. A method for operating a signal conditioning circuit for receiving signals whose data content has been encoded using various modulation types, comprising:
providing the signal conditioning circuit;
adjusting a first filter bandwidth for a polyphase filter in the signal conditioning circuit;
supplying a signal to the signal conditioning circuit;
processing the supplied signal;
demodulating the first and second components to produce a string of bits;
ascertaining a second filter bandwidth for the polyphase filter from the string of bits;
producing a control signal; and
varying a component determining the filter bandwidth based on the control signal in order to adjust the second filter bandwidth.

17. The method of claim 16, wherein the step of processing the supplied signal comprises:
converting and braking-down the signal into a first and a second component;
filtering the first and second components in the polyphase filter;
amplifying the first and second components; and
converting the first component and the second component into a digital value.

18. A signal conditioning circuit, comprising:
a vector demodulator having an input and a first and a second output, the demodulator configured to decode a signal applied to the input into a first component and a second component and to output the first component to the first output and the second component to the second output;
a polyphase filter having an adjustable filter bandwidth and a first and a second input connected to the first and second outputs of the vector demodulator;
a first amplifier circuit comprising a first input connected to a first output of the polyphase filter and a second input connected to a second output of the polyphase filter, wherein the first amplifier circuit is configured to amplify signals applied to the input using an adjustable gain; and
a first analog/digital converter, connected to a first output of the amplifier circuit, and a second analog/digital converter, connected to a second output of the amplifier circuit, the first and the second analog/digital converter being configured to output a digital value derived from a signal input applied thereto.

19. The signal conditioning circuit of claim 18, further comprising a second amplifier circuit arranged in parallel with the first amplifier circuit comprising first and second outputs having a third and a fourth analog/digital converter connected to the first and second outputs, wherein the second amplifier circuit is configured to have a limiting gain response.

20. The signal conditioning circuit of claim 19, wherein one or more of the first amplifier circuit and the second amplifier circuit, respectively, comprise at least two amplifiers, having a first amplifier from the at least two amplifiers configured to amplify and output a signal applied to the first input, and a second amplifier from the at least two amplifiers configured to amplify and output a signal applied to the second input.
